(19) United States
(12) Patent Application Publication
(10) Pub. No.: US 2020/0269768 A1
(43) Pub. Date: Aug. 27, 2020

(54) Bicycle and Accessory Carrier Mount

(71) Applicant: Andrew Jarrard, Raleigh, NC (US)

(72) Inventor: Andrew Jarrard, Raleigh, NC (US)

(21) Appl. No.: 16/285,693

(22) Filed: Feb. 26, 2019

(51) Int. Cl. B60R 9/10

(52) U.S. Cl. CPC B60R 9/10

(57) ABSTRACT

A vehicle carrier system for a bicycle having a single suction vacuum cup that mounts to a smooth surface on a vehicle by means of a single suction vacuum cup configured to secure the front forks of a bicycle to the device and a back carrier system having a single suction vacuum cup that mounts to a smooth surface on a vehicle configured to secure the back wheel of the bicycle. And a tether that is tightened around the frame of the bicycle and secured inside the vehicle for security from theft and for safety purposes in case the suction vacuum cup loses vacuum or suction.

### CROSS-REFERENCE TO RELATED APPLICATIONS

62/617,455

### FEDERALLY SPONSORED RESEARCH

None

### SEQUENCE LISTING

None

### BACKGROUND OF THE INVENTION

### Field of Invention

The present invention relates to a detachable bicycle carrier mount for vehicles that allows a user to easily attach and detach a bicycle via a suction vacuum cup mount that attaches to the surface of a vehicle. This invention relates to a mechanical process of an attached vacuum cup to a smooth surface of a vehicle, and also a mechanical means and method of attaching a bicycle by its frames to the mounted vacuum cup via a twist and lock cam-lever fastening device utilizing the forks of the bicycle in the front and the wheel in the back.

### Background Art of the Invention

There have been many inventions related to carrying bicycles on vehicles for ease of transportation. These inventions include racks that attach to the top of vehicles as well as racks that attach to a vehicle's trailer hitch or trunk. These racks are heavy and not easily stored or removed from the vehicles. The market needs a bike rack that is small and easily installed and removed. This invention needs to be easily stored inside the vehicle once removed. This invention was developed with these ideas to fill this niche.

There are other similar devices in existence that use vacuum cups to secure themselves to smooth surfaces. However, the existing devices use multiple vacuum cups that become more cumbersome to use and maintain, as well as require more surface area to mount to. This single suction vacuum cup device for securing the front of a bicycle and a single suction vacuum cup for securing the back wheel offer many advantages over permanent bicycle carriers and removable carriers.

Typical bike racks are made to fit atop certain car tops and sports utility vehicles. This device can be mounted to any type of vehicle with smooth surfaces where a single suction vacuum cup can safely be attached.

Therefore, a carrier such as this invention that is easily installed, removed, and stored and can fit multiple vehicles is an advantage over permanent carriers and other multi-vacuum cup carriers in the market and shows a need for this invention.

### BRIEF SUMMARY OF THE INVENTION

This device provides for a small, easily installed, easily removed method of attaching a bicycle to a vehicle via a suction vacuum cup and front bicycle fork mount. The present invention consists of a suction vacuum cup where vacuum is applied to the cup when attached to a smooth surface of a vehicle. The vacuum is applied via a pump attached to the cup. The vacuum can be relieved in order to remove the cup. Attached to the cup is a bicycle front fork mount. This invention requires removal of the front tire and then attaching the front bicycle fork to the bike mount. The bike mount is bolted to the suction vacuum cup.

### BRIEF DESCRIPTION OF THE DRAWINGS

FIG. 1 is an isometric side view illustrating a single suction vacuum cup with a cam-lever bike fork mounting device as shown.

FIG. 2 is an exploded view of the same isometric side view as shown in FIG. 1.

FIG. 3 is an isometric opposite side view illustrating a single suction vacuum cup with a vacuum pump as shown.

FIG. 4 is an exploded isometric opposite side view illustrating a single suction vacuum cup with a vacuum pump as shown in FIG. 3.

FIG. 5 is an isometric view of a single suction vacuum cup bicycle back tire mount.

### DETAILED DESCRIPTION OF THE INVENTION

In accordance with the present invention, a novel bike rack transportation means has been provided for that includes a single suction vacuum cup, a front bicycle fork mounting rack, and a means for removal and attachment of the suction vacuum cup via a vacuum pump button. The bike mount for the forks is attached to the suction vacuum cup via two fasteners. The suction vacuum cup contains a vacuum pump with a release button to be used for applying and releasing suction. In accordance with the descriptions and the drawings, the suction vacuum cup can be mounted to a smooth surface on a vehicle and then attached by pumping the pump button. The pump draws air out of the cavity between the suction vacuum cup's inner surface and the smooth surface on the vehicle. The removal of the air causes the suction vacuum cup to adhere to the smooth surface of the vehicle. The pump also contains a suction release button that is used to release the vacuum in order to remove the suction vacuum cup from the vehicle. In accordance with the description and drawings, the present invention solves the problem of bulky bike racks, as older bike racks are heavy and hard to install on vehicles. This invention is of smaller and lighter weight than older models of bike racks. This invention also provides for a novel method of attachment and removal from a vehicle via a suction vacuum cup.

This present invention works by providing a means for the following: (1) attachment of the front bicycle fork to a standard bike mount that is bolted to a suction vacuum cup, and (2) attachment of the suction vacuum cup to a smooth surface on a vehicle. The preferred embodiment of this invention would be to attach that suction vacuum cup to the back windshield or roof

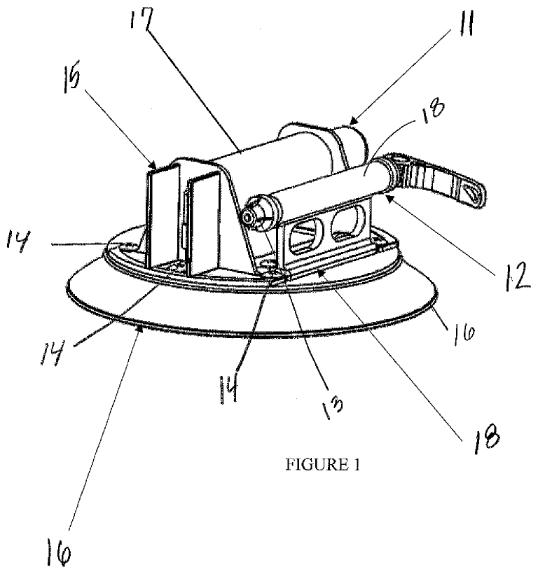

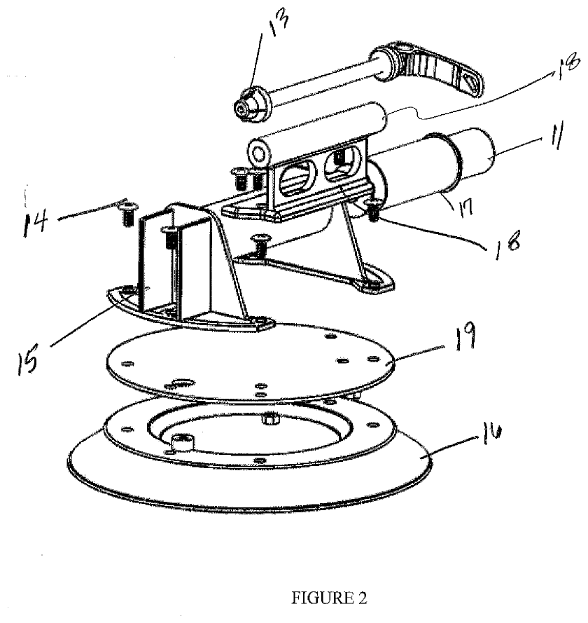

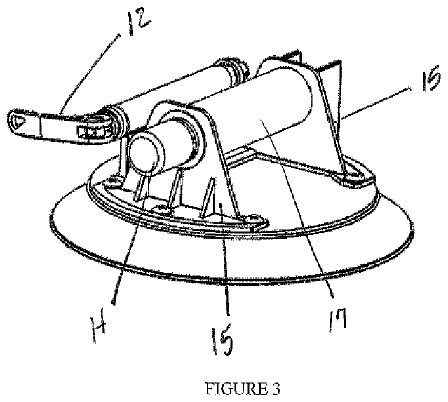

As shown in FIG. 1-5, an embodiment of the present disclosure referred to as the front bike fork carrier system includes a pump button 11, a quick fork release tensioner lever 12, a plurality of screws 14, a tensioner nut 13, two bracket frames 15 on each side of the pump chamber 17, a back rack fork spacer 18, and a circular mounting frame 19.

As shown in FIG. 1, part 12 is mounted to part 19 via a bracket 18.

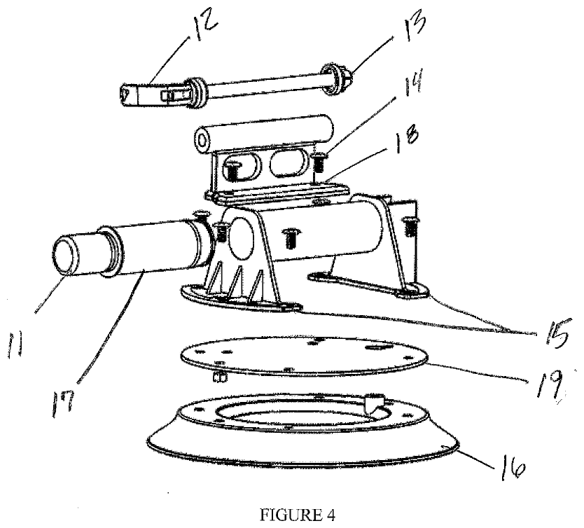

As shown in FIG. 4, the pump button 11 would be pumped after the suction vacuum cup 16 is placed on a smooth surface such as a window of a car or the car roof. Part 16, the suction vacuum cup, is the vacuum attached to the vehicle by pumping out the air with part 11, the pump button. Enough vacuum is applied in order to maintain contact between a smooth surface of the car and the suction vacuum cup.

After securing the attached front suction carrier system as show in FIGS. 1-4, a front bike fork is inserted by straddling the forks on each side of part 18, the spacer. Then part 12 may be twisted and closed to attach the front bike forks to the carrier device.

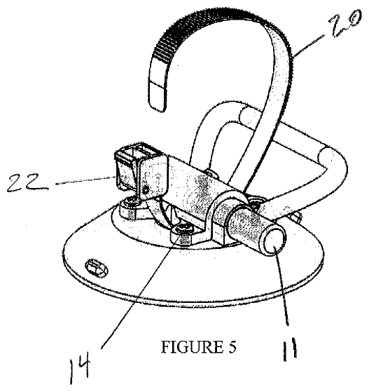

As shown in FIG. 5, the rear bicycle tire carrier is strapped to the single suction vacuum cup carrier via part 20 and a clip, part 22. Part 22 is a clip with a release button allowing the user to securely attach the rear wheel to the single suction vacuum cup.

In operation, the user first secures the front suction vacuum cup to a vehicle and then attaches the front fork of the bike. Then, the user secures the rear suction vacuum cup in a location that will accommodate strapping the rear wheel down. The user will pump the suction button to obtain an adequate vacuum between the suction vacuum cup and the surface of the car in order for the bike to remain stable while the vehicle is in operation.

As shown and described herein a single suction vacuum cup for the front mount and the rear mount is a significant advantage of other bicycle carrier mechanisms.

1. A bicycle carrier system for an automobile consisting essentially of: a front vacuum device;
a rear vacuum device, each of the front and rear vacuum devices having a circular rubberized suction cup and a pump button actuator that, when depressed in succession, causes a suction to form between the vacuum device and a surface of the automobile; and,
a first frame attached to the circular rubberized suction cup of the front vacuum device; and
a second frame attached to the circular rubberized suction cup of the rear vacuum device.

2. The bicycle carrier system of claim 1 wherein a top of the first frame is shaped to match a front bicycle fork with the wheel removed and a bottom of the first frame being coupled to the front vacuum device.

3. The bicycle carrier system of claim 2 including a strap and a clip that fits the strap allowing a rear tire of a bicycle to be securely attached to a top of the second frame.

4. (canceled)

5. A bicycle carrier system for a vehicle comprising:
a bicycle fork spacer configured to receive a fork of a bicycle frame, the bicycle fork spacer including a tubular channel that extends a length of the bicycle fork spacer;
a tensioner pin that extends in the tubular channel;
a tensioner nut moveably coupled to a first end of the tensioner pin;
a tensioner lever moveably coupled to a second end of the tensioner pin, wherein the tensioner lever is movable to releasably couple the fork to the bicycle fork spacer;
a first bracket at the first end of the tensioner pin;
a second bracket at the second end of the tensioner pin;
a circular mounting frame having the first bracket located proximate to a perimeter of the circular mounting frame and having the second bracket located proximate to the perimeter of the circular mounting frame opposite the first bracket; and
a vacuum device coupled to the circular mounting frame, the vacuum device configured to releasably couple to a first location on a surface of the vehicle.

6. The bicycle carrier system of claim 5 wherein the bicycle fork spacer comprises a front bicycle fork spacer configured to receive a front fork of the bicycle frame and the vacuum device comprises a first vacuum device, the bicycle carrier system further comprising:
a bicycle rear wheel receiver mount including a frame;
a strap coupled to the frame of the bicycle rear wheel receiver mount, the strap configured to hold a rear wheel of the bicycle frame; and
a rear vacuum device coupled to the bicycle rear wheel receiver mount, the rear vacuum device configured to releasably couple the bicycle rear wheel to a second location on the surface of the vehicle.

7. The bicycle carrier system of claim 6 wherein the front bicycle fork spacer is configured to capture a first blade of the front fork between the tensioner nut and the front bicycle fork spacer and configured to capture a second blade of the front fork between the tensioner lever and the front bicycle fork spacer.

8. The bicycle carrier system of claim 5 wherein the bicycle fork spacer comprises a front bicycle fork spacer configured to receive a front fork of the bicycle frame, the bicycle carrier system further comprising:
a strap configured to couple to a wheel of the bicycle at and opposite end of the fork of the bicycle frame.

9. The bicycle carrier system of claim 5 wherein the perimeter of the circular mounting frame substantially follows a perimeter of the vacuum device.

10. The bicycle carrier system of claim 5 wherein the vacuum device comprises a stand-alone vacuum device configured to hold the bicycle frame to the surface of the vehicle.

11. The bicycle carrier system of claim 6 wherein the bicycle carrier system is free of a rigid member that extends between multiple vacuum devices.

12. The bicycle carrier system of claim 5 further comprising:
a release button configured to release suction provided by the vacuum device.

13. A recreational article carrier system for a vehicle, the system comprising:
a first vacuum device configured to releasably couple to a first location on a surface of a vehicle;
a first mounting frame coupled to the first vacuum device and being the only vacuum device fastened to the first mounting frame, wherein the first mounting frame is configured to releasably couple to a first portion of a reactional article;
a second vacuum device configured to configured to releasably couple to a second location on the surface of the vehicle; and
a second mounting frame coupled to the second vacuum device and being the only vacuum device fastened to the second mounting frame, wherein the second mounting frame is configured to releasably couple to a second portion of a reactional article and the system is free of a rigid member that extends between the first and second vacuum devices outside the recreational article itself.

14. The recreational article carrier system of claim 13 further comprising a release button configured to release suction provided by the first vacuum device.
